(19) United States
(12) Patent Application Publication
(10) Pub. No.: US 2014/0218378 A1
(43) Pub. Date: Aug. 7, 2014

(54) SYSTEM ON CHIP FOR UPDATING PARTIAL FRAME OF IMAGE AND METHOD OF OPERATING THE SAME

(71) Applicant: SAMSUNG ELECTRONICS CO., LTD., SUWON-SI (KR)

(72) Inventors: JONG HO ROH, Yongin-Si (KR); Kyoung Man Kim, Suwon-Si (KR); Young Mok Song, Seoul (KR); Jong Hyup Lee, Yongin-Si (KR); Jae Young Hur, Hwaseong-Si (KR); Sung Min Hong, Hwaseong-Si (KR); Byung Tak Lee, Yongin-Si (KR); Kee Moon Chun, Seongnam-Si (KR)

(73) Assignee: SAMSUNG ELECTRONICS CO., LTD., SUWON-SI (KR)

(21) Appl. No.: 14/169,410

(22) Filed: Jan. 31, 2014

(30) Foreign Application Priority Data
Feb. 1, 2013 (KR) 10-2013-0012007

(51) Int. Cl. G06T 1/60

(52) U.S. Cl. CPC G06T 1/60
USPC 345/519

(57) ABSTRACT

A system on chip (SoC) and a method of operating the same are provided. The SoC includes a central processing unit (CPU) controlling a memory operation and a display operation on a current frame of an image based on generation of the image and an interrupt signal; an image generator requesting data of the current frame from a memory according to control of the CPU; a UD unit determining whether the current frame is updated, detecting whether an update region is a partial frame based on virtual addresses included in a request of the image generator, and outputting the interrupt signal corresponding to the update region to the CPU; a memory controller storing the update region in the memory according to the control of the CPU; and a display controller accessing the memory and outputting the update region to a display device according to the control of the CPU.

### CROSS-REFERENCE TO RELATED APPLICATIONS

This application claims priority under 35 U.S.C. §119(a) to Korean Patent Application No. 10-2013-0012007 filed on Feb. 1, 2013, the disclosure of which is hereby incorporated by reference in its entirety.

### TECHNICAL FIELD

Embodiments of the inventive concept relate to a system on chip (SoC), and more particularly, to a SoC for updating a partial frame of an image and a method of operating the same.

### DISCUSSION OF THE RELATED ART

With the increase of image resolution in mobile devices, data traffic between a mobile application processor and a display driver integrated circuit (IC) is rapidly increasing. Accordingly, power consumption of the mobile application processor and/or the display driver IC is also continuously increasing.

Conventional mobile telephones that are primarily concerned with voice calls have rapidly been replaced by smart phones that process and display a large amount of multimedia data. A display driver IC implemented in smart phones frequently operates to display multimedia data such as still image signals and moving image signals on a display device. Accordingly, the battery life of smart phones decreases as more multimedia data, for example, image signal data representing higher resolution images, is processed displayed. The battery life indicates a time for which a battery can be cumulatively used on a single charge.

### SUMMARY

According to some embodiments of the inventive concept, there a system on chip (SoC) includes a central processing unit (CPU) configured to control a memory operation and a display operation on a current frame of an image based on generation of the image and an interrupt signal. An image generator is configured to request data of the current frame from a memory according to control of the CPU. A UD unit is configured to determine whether the current frame is updated, to detect whether an update region is a partial frame based on virtual addresses included in a request of the image generator, and to output the interrupt signal corresponding to the update region to the CPU. A memory controller is configured to store the update region in the memory according to the control of the CPU. A display controller is configured to access the memory and output the update region to a display device according to the control of the CPU.

The UD unit may include a special function register (SFR) configured to store frame region information. A partial image checker may be configured to compare the virtual addresses included in the request of the image generator with the frame region information to detect whether the update region is the partial frame or a full frame and to output a detection result. An update detector may be configured to compare the current frame with a previous frame and transmit a comparison result to the SFR and to transmit the data of the current frame to the memory when an update occurs. An interrupt generator may be configured to output the interrupt signal to the CPU based on the comparison result and the detection result.

The frame region information may include a full frame start address and a full frame end address.

When update detection is enabled, the partial image checker may determine the detection result as the partial frame when a first input address included in the request of the image generator is not the full frame start address and subsequent input addresses are linear.

The SFR may store the first input address and a last input address. The interrupt generator may generate a partial interrupt signal based on the detection result and the comparison result.

When update detection is enabled, the partial image checker may determine the detection result as the partial frame when a first input address included in the request of the image generator is the full frame start address, a last input address is not the full frame end address, and input addresses between the first input address and the last input address are linear.

The SFR may store the first input address and the last input address. The interrupt generator may generate a partial interrupt signal based on the detection result and the comparison result.

When update detection is enabled, the partial image checker may determine the detection result as the full frame when a first input address included in the request of the image generator is the full frame start address and a last input address is the full frame end address.

The interrupt generator may generate a full interrupt signal based on the detection result and the comparison result.

The update region may be the image corresponding to the first input address, the last input address, and input addresses between the first input address and the last input address.

The UD unit may further include a translation lookaside buffer (TLB) configured to store a plurality of page table entries including a physical address, which matches a virtual address in the request of the image generator, and an Is Frame Buffer field indicating whether the virtual address relates to the image.

The partial image checker may enable a frame detection operation based on the Is Frame Buffer field.

According to embodiments of the inventive concept, there is provided a method of operating a SoC. The method includes controlling an image generator to request generation of an image and to enable an update detection operation using a CPU. Whether an update region in a current frame of the image is a partial frame is detected based on frame region information. Whether an update occurs is determined by comparing the current frame with a previous frame of the image. An interrupt signal corresponding to the update region is generated when the update occurs. The update region is stored in a memory when the interrupt signal is generated. The memory is accessed and the update region is read and output to a display device using a display controller until all of the update region is output.

According to embodiments of the inventive concept, there is provided an application processor including a CPU configured to control a memory operation and a display operation on a current frame of an image based on generation of the image and an interrupt signal. A graphics processing unit (GPU) is configured to request data of the current frame from a memory according to control of the CPU. A memory management unit (MMU) is configured to translate virtual addresses included in a request of the GPU into physical addresses to determine whether the current frame is updated, to detect whether an update region is a partial frame based on the virtual addresses, and/or to output the interrupt signal corresponding to the update region to the CPU. A memory controller is configured to write the update region to the memory according to the control of the CPU. A display controller is configured to access the memory and output the update region to a display device according to the control of the CPU.

According to embodiments of the inventive concept, there is provided a mobile device including a GPU configured to request and process generation of an image. A UD unit is configured to determine whether a current frame of the image is updated, to detect whether an update region is a partial frame based on virtual addresses included in a request of the GPU, and/or to output an interrupt signal corresponding to the update region. A CPU is configured to control an operation of a memory controller on the update region and an operation of a display controller on the update region in response to the interrupt signal. The memory controller is configured to write the update region to the memory when the interrupt signal is generated. The display controller is configured to output the update region to a display device according to control of the CPU.

A mobile electronic device includes a memory device, a display device, and a system-on-chip (SoC). The SoC includes a central processing unit (CPU) configured to control an operation of the memory device. An image generator is configured to request image data from the memory device. An update unit is configured to determine whether a current frame of the requested image data is updated as compared to a previous frame of the requested image data and, where it is determined that the current frame is updated, to determine whether the updates apply only to a partial frame of the current frame and to provide an interrupt signal when it is determined that the current frame is updated and the updates apply only to the partial frame. The display device is configured to refresh only the partial frame when the interrupt signal is provided.

### BRIEF DESCRIPTION OF THE DRAWINGS

The above and other features and aspects of the inventive concept will become more apparent by describing in detail exemplary embodiments thereof with reference to the attached drawings in which:

FIG. 1 is a block diagram of a system according to embodiments of the inventive concept;

FIG. 2 is a detailed block diagram of a system on chip (SoC) illustrated in FIG. 1;

FIG. 3 is a conceptual diagram of the operation of a SoC according to embodiments of the inventive concept;

FIG. 4 is a detailed block diagram of the SoC according to embodiments of the inventive concept;

FIG. 5 is a conceptual diagram of the operation of detecting a partial frame in a display image;

FIG. 6 is a conceptual diagram of the operation of detecting a full frame in a display image;

FIG. 7 is a flowchart of a method of operating a SoC according to embodiments of the inventive concept;

FIG. 8 is a flowchart of a method of operating a SoC performed after interrupt generation in the method illustrated in FIG. 7;

FIG. 9 is a detailed block diagram of the SoC according to embodiments of the inventive concept;

FIG. 10 is a table showing a page descriptor field included in a translation lookaside buffer (TLB) illustrated in FIG. 9;

FIG. 11 is a flowchart of a method of operating the SoC illustrated in FIG. 9; and

FIG. 12 is a block diagram of a system 100 including the SoC according to embodiments of the inventive concept.

### DETAILED DESCRIPTION OF THE EMBODIMENTS

The inventive concept now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers may refer to like elements throughout.

It will be understood that when an element is referred to as being “connected” or “coupled” to another element, it can be directly connected or coupled to the other element or intervening elements may be present.

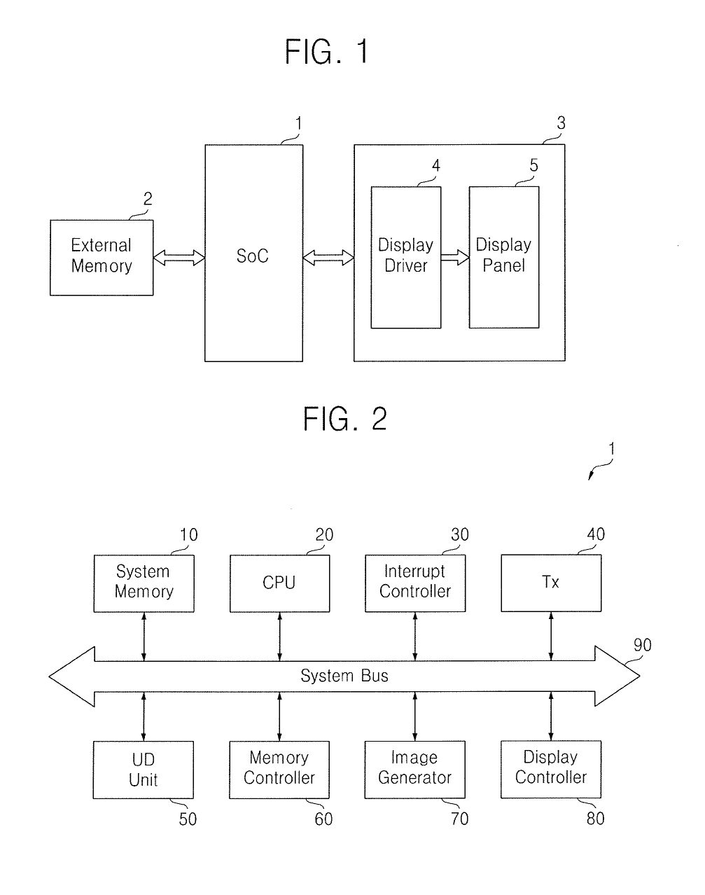

FIG. 1 is a block diagram of a system according to embodiments of the inventive concept. The system includes an external memory 2, a system on chip (SoC) 1, and a display device 3. Each of the elements 1, 2, and 3 may be implemented in a separate chip, as shown, or multiple elements may be implemented on a single chip. The system may also include other elements (e.g., a camera interface). The system may be a mobile device, such as a mobile phone, a smart phone, a table personal computer (PC), a personal digital assistant (PDA), a portable multimedia player (PMP), an MP3 player, or an automotive navigation system. The system may also be a handheld device or a handheld computer, which can display a still image signal (or a still image) or a moving image signal (or a moving image) on a display panel 5.

The external memory 2 stores program instructions executed in the SoC 1. The external memory 2 may also store image data for displaying still images or moving images on the display device 3. The moving images are a series of different still images presented for a short period of time. The image data may be divided into two types: static image data and dynamic image data. The static image data is used to display still images on the display device 3. The dynamic image data is used to display moving images on the display device 3.

The external memory 2 may be a volatile or non-volatile memory. The volatile memory may be dynamic random access memory (DRAM), a static RAM (SRAM), thyristor RAM (T-RAM), zero capacitor RAM (Z-RAM), or twin transistor RAM (TTRAM). The non-volatile memory may be electrically erasable programmable read-only memory (EEPROM), flash memory, magnetic RAM (MRAM), phase change RAM (PRAM), or resistive memory.

The SoC 1 controls the external memory 2 and/or the display device 3. The SoC 1 may be called an integrated circuit (IC), a processor, an application processor, a multimedia processor, or an integrated multimedia processor.

The display device 3 includes a display driver 4 and a display panel 5. The SoC 1 and the display driver 4 may be implemented together in a single module, a single SoC, or a single package (e.g., a multi-chip package). Alternatively, or additionally, the display driver 4 and the display panel 5 may be implemented together in a single module.

The display driver 4 controls the operation of the display panel 5 according to signals output from the SoC 1. For example, the display driver 4 may transmit image data received from the SoC 1 as an output image signal to the display panel 5 through a selected interface.

The display panel 5 may display the output image signal received from the display driver 4. The display panel 5 may be implemented by a liquid crystal display (LCD) panel, a light emitting diode (LED) display panel, organic LED (OLED) display panel, or an active-matrix OLED (AMOLED) display panel.

FIG. 2 is a detailed block diagram of the SoC 1 illustrated in FIG. 1. Referring to FIG. 2, the SoC 1 may include a system memory 10, a central processing unit (CPU) 20, an interrupt controller 30, a transmitter 40, a UD unit 50, a memory controller 60, an image generator 70, and a display controller 80.

The system memory 10 may store instructions and parameters necessary for the operation of the SoC 1. The CPU 20 may control the overall operation of the SoC 1. The CPU 20 may control the operation of each of the elements 10, 30, 40, 50, 60, 70, and 80. For example, the CPU 20 may request the image generator 70 to generate or process an image. When receiving an interrupt signal from the UD unit 50, the CPU 20 may also control the display controller 80 to control operations necessary to update a current frame of a display image. The CPU 20 may be implemented by a multi-core processor. The multi-core processor is a single computing component with two or more independent cores.

The interrupt controller 30 controls interrupts generated during the operation of the SoC 1. The interrupt controller 30 receives an interrupt from each element, adjusts the execution sequence of interrupts, and transmits the execution sequence to the CPU 20. Alternatively, the interrupt controller 30 may generate and transmit an interrupt to the CPU 20 when an update occurs with respect to frame data.

The transmitter (Tx) 40 may exchange instruction signals and data, which have been converted according to various interface protocols, with the display device 3. Although the transmitter 40, it will be understood that signals and data are transmitted to and received from the display device 3 through the transmitter 40.

The UD unit 50 determines whether a current frame of an image displayed is updated and detects whether an update region is a partial frame based on a virtual address included in a request from the image generator 70. The UD unit 50 outputs an interrupt signal corresponding to the update region to the CPU 20. The UD unit 50 may be implemented as a separate module within the SoC 1 or may be implemented within a memory management unit (MMU). The operation of the UD unit 50 will be described in detail later.

The memory controller 60 may control the operation of the external memory 2 when exchanging data with the external memory 2 connected to the SoC 1. The memory controller 60 may access the external memory 2 to read, write, or erase image data at the request of the CPU 20, the image generator 70, or the display controller 80. The memory controller 60 may control the update region of the current frame to be stored in the external memory 2 according to the control of the CPU 20. Although the operation is explained in units of frames for clarity of the description, the operation may be performed on a predetermined region in a full image at a time.

The image generator 70 may read and execute program instructions related to graphics processing. The image generator 70 may be implemented by a graphics engine, a graphics processing unit (GPU), or a 2D graphics accelerator. The image generator 70 may generate or process an image according to the control of the CPU 20. According to the control of the CPU 20, the image generator 70 may request data for a current frame from the external memory 2.

The display controller 80 controls the operation of the SoC 1 with respect to the display device 3 or the operation of the display device 3 with respect to the SoC 1. The display controller 80 may access the external memory 2 and output an update region to the display device 3 according to the control of the CPU 20. A system bus 90 connects the elements 10 through 80 of the SoC 1 with one another and functions as a data communication passage among the elements 10 through 80. The system bus 90 may include sub-buses for data communication between predetermined elements.

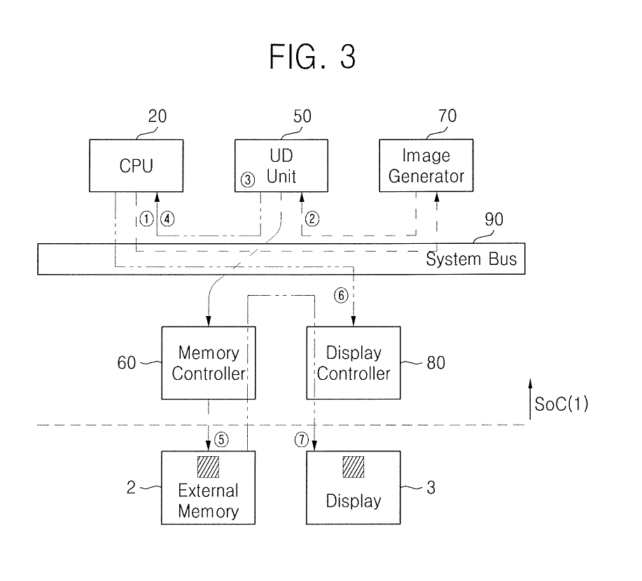

FIG. 3 is a conceptual diagram of the operation of the SoC 1 according to embodiments of the inventive concept. Referring to FIG. 3, the CPU 20 instructs the image generator 70 to generate or process an image to be output to the display device 3 (operation \textcircled{1}). In response to the instruction of the CPU 20, the image generator 70 requests the UD unit 50 to perform an updating operation on a current frame of the image (operation \textcircled{2}).

The UD unit 50 compares data of a previous frame with data of the current frame and determines whether an update is necessary. When updating is necessary, the UD unit 50 compares virtual addresses included in the request of the image generator 70 with frame region information and detects whether an update region requested by the image generator 70 is a partial frame or a full frame (operation \textcircled{3}). The CPU 20 may set in the UD unit 50 the frame region information (e.g., a full frame start address and a full frame end address) regarding the full frame of the image in advance to operation \textcircled{1}.

The UD unit 50 outputs an interrupt signal corresponding to the update region to the CPU 20 (operation \textcircled{4}). The UD unit 50 may output a partial interrupt signal to the CPU 20 when it is determined that the current frame needs to be updated and the update region is the partial frame. The UD unit 50 may output a full interrupt signal to the CPU 20 when it is determined that the current frame needs to be updated and the update region is the full frame.

The UD unit 50 translates virtual addresses included in the request of the image generator 70 into physical addresses and accesses the external memory 2 through the memory controller 60 (operation \textcircled{5}). The memory controller 60 writes the current frame that has been processed by the image generator 70 to the external memory 2.

Upon receiving the interrupt signal from the UD unit 50, the CPU 20 controls the display controller 80 to transmit data corresponding to the update region to the display device 3 (operation \textcircled{6}). According to the control of the CPU 20, the display controller 80 accesses the external memory 2 and outputs the data of the update region in the current frame to the display device 3 (operation \textcircled{7}). When the CPU 20 receives the partial interrupt signal, the display controller 80 outputs the data of an updated partial frame to the display device 3. When the CPU 20 receives the full interrupt signal, the display controller 80 outputs the data of an updated full frame to the display device 3.

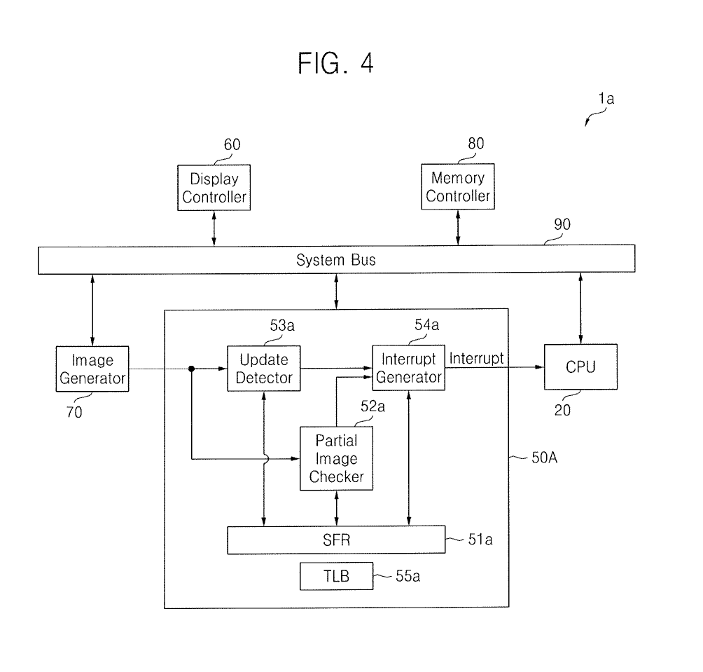

FIG. 4 is a detailed block diagram of a SoC 1a according to embodiments of the inventive concept. Referring to FIG. 4, a UD unit 50A includes a special function register (SFR) 51a, a partial image checker 52a, an update detector 53a, and an interrupt generator 54a.

The SFR 51a stores frame region information of an image. The frame region information may be preset by a user or may be set according to the specifications of a display device. The frame region information may include a full frame start address and a full frame end address, which may be set by the CPU 20.

Virtual addresses input to the UD unit 50 in correspondence with the data of a display image are linear. Accordingly, the UD unit 50 can detect whether virtual addresses included in a request from the image generator 70 relate to a previous frame or a current frame and whether a region for which an input address is updated is a partial frame or a full frame based on a full frame start address and a full frame end address.

The SFR 51a also stores a first input address and a last input address, which are received at the request of the image generator 70. The first and last input addresses are used for the display controller 80 to access only data of an update region in the external memory 2.

The SFR 51a may also store information about a current frame, e.g., current frame information. The current frame information may be used as previous frame information in the following updating operation of the SoC 1a. When determining whether a current frame is updated, the update detector 53a may compare current frame information with previous frame information. The information may be entire data of a previous frame, a hash value, a checksum result, or a cyclic redundancy check (CRC) result.

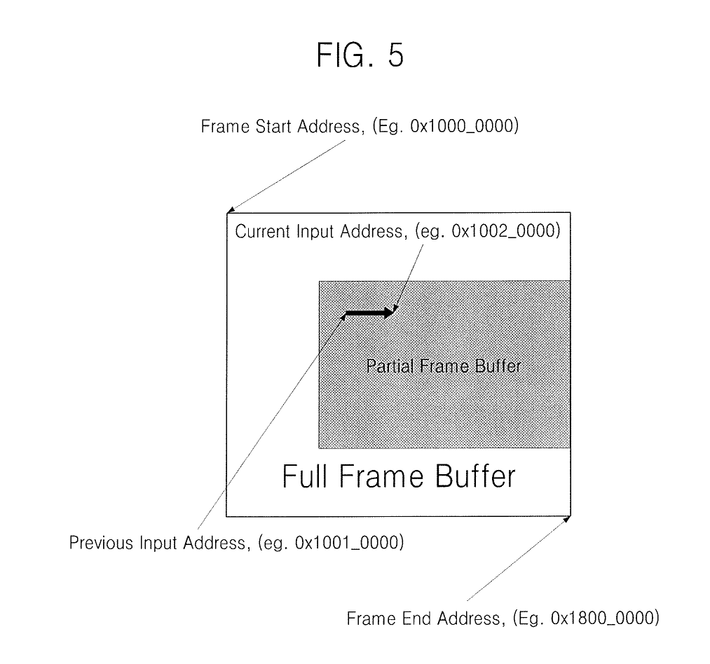

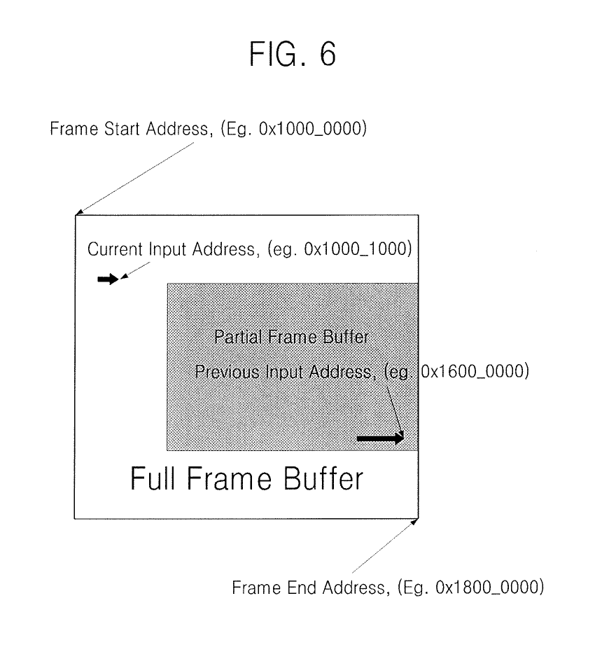

The partial image checker 52a compares virtual addresses included in a request from the image generator 70 with frame region information stored in the SFR 51a, detects whether an update region is a partial frame or a full frame, and outputs a detection result to the interrupt generator 54a. The detection of the partial frame or the full frame will be described with reference to FIGS. 5 and 6 later.

The update detector 53a compares current frame information in the request of the image generator 70 with previous frame information stored in the SFR 51a, transmits a comparison result to the interrupt generator 54a, and transmits the data of a current frame to the external memory 2 when an update is detected.

The interrupt generator 54a generates an interrupt signal according to the detection result from the partial image checker 52a and the comparison result from the update detector 53a. The interrupt signal is applied to the CPU 20. When it is determined that the update occurs and the update region is the partial frame, the interrupt generator 54a generates a partial interrupt signal. When it is determined that the update occurs and the update region is the full frame, the interrupt generator 54a generates a full interrupt signal. When it is determined that no update occurs, the interrupt generator 54a does not generate an interrupt signal.

The UD unit 50A may also include a translation lookaside buffer (TLB) 55a. The TLB 55a is a buffer storing mapping information between virtual addresses and physical addresses. In a case of TLB hit in which there is in the TLB 55a a physical address matching a virtual address included in the request of the image generator 70, the physical address in the external memory 2 is accessed. In a case of TLB miss in which there is no physical address matching the virtual address in the TLB 55a, a page table (not shown) in the external memory 2 is accessed, a page table walk is performed, and then a corresponding physical address is accessed.

FIG. 5 is a conceptual diagram of the operation of detecting a partial frame in a display image. FIG. 6 is a conceptual diagram of the operation of detecting a full frame in a display image. Referring to FIGS. 5 and 6, the full frame of a display image has virtual addresses from a full frame start address (e.g., 0x1000_{—}0000) to a full frame end address (e.g., 0x1800_{—}0000). The virtual addresses of the frame are linear.

It is assumed that a previous input address is 0x1001_{—}0000 as shown in FIG. 5. When a current input address is 0x1002_{—}0000, the current input address is greater than the full frame start address and less than the full frame end address and the current input address is greater than the previous input address. The relationship between the previous input address and the current input address is linear. In this case, the partial image checker 52a determines that the update region is the partial frame based on the input addresses.

It may be assumed that the previous input address is 0x1600_{—}0000 as shown in FIG. 6. When the current input address is 0x1000_{—}1000, the current input address is greater than the full frame start address and less than the full frame end address but the current input address is not greater than the previous input address. For example, unlike as illustrated in FIG. 5 and discussed above, the relationship between the previous input address and the current input address is not linear. In this case, the partial image checker 52a determines that the partial frame is not updated based on the input addresses.

The partial image checker 52a determines that the update region is the partial frame when a first input address is not the full frame start address and subsequent input addresses are linear. The partial image checker 52a determines that the update region is the partial frame when the first input address is the full frame start address, a last input address is not the full frame end address, and input addresses between the first and last input addresses are linear. The partial image checker 52a determines that the update region is the full frame when the first input address is the full frame start address and the last input address is the full frame end address.

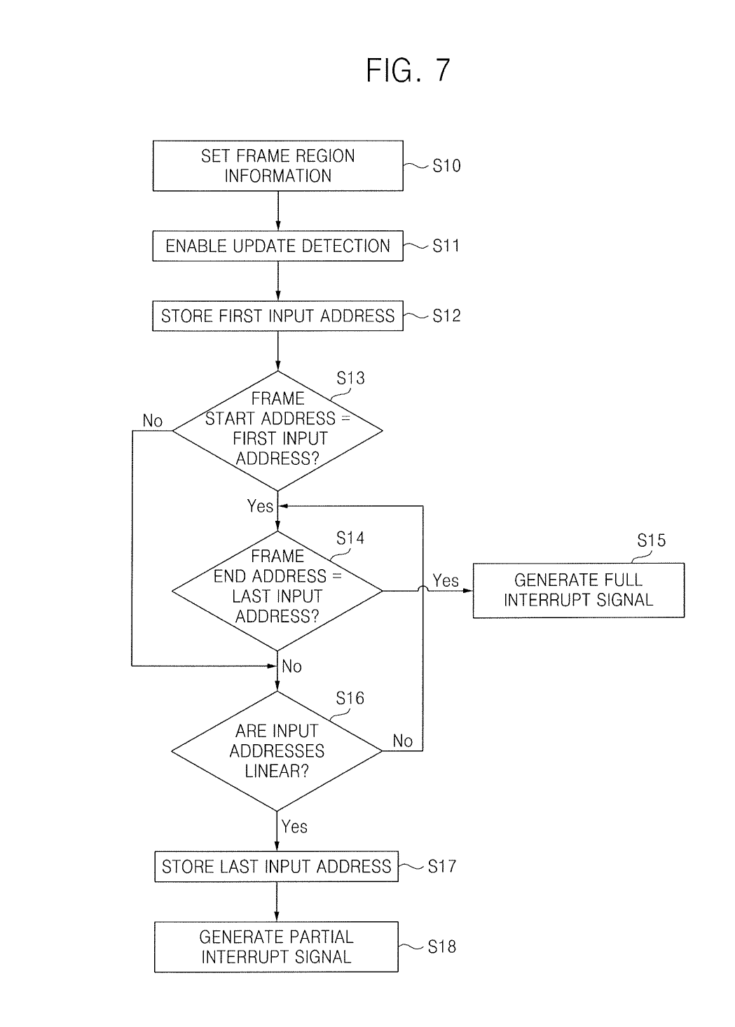

FIG. 7 is a flowchart of a method of operating the SoC 1a according to embodiments of the inventive concept. Referring to FIG. 7, the CPU 20 sets frame region information in the UD unit 50A in operation S10. The frame region information includes a full frame start address and a full frame end address.

The CPU 20 instructs the image generator 70 to generate or process an image. The image generator 70 requests the UD unit 50A to operate on a current frame according to the instruction of the CPU 20 and the UD unit 50A enables an update detection operation in operation S11. The UD unit 50A stores a first input address included in the request from the image generator 70 in the SFR 51a in operation S12 while translating a virtual address into a physical address using TLB 55a. When the first input address is the same as the full frame start address set in the SFR 51a in operation S13 and a last input address is the same as the full frame end address set in the SFR 51a in operation S14, the UD unit 50A determines that a requested update region is a full frame and, when an update occurs, generates a full interrupt signal in operation S15.

When the first input address is not the same as the full frame start address set in the SFR 51a in operation S13 and subsequent input addresses are linear in operation S16, the UD unit 50A determines that the update region is a partial frame and stores the last input address in operation S17. When the update occurs, the UD unit 50A generates a partial interrupt signal in operation S18.

When the first input address is the same as the full frame start address set in the SFR 51a in operation S13, the last input address is not the same as the full frame end address set in the SFR 51a in operation S14, and subsequent input addresses are linear in operation S16, the UD unit 50A determines that the update region is the partial frame and stores the last input address in operation S17. When the update occurs, the UD unit 50A generates the partial interrupt signal in operation S18.

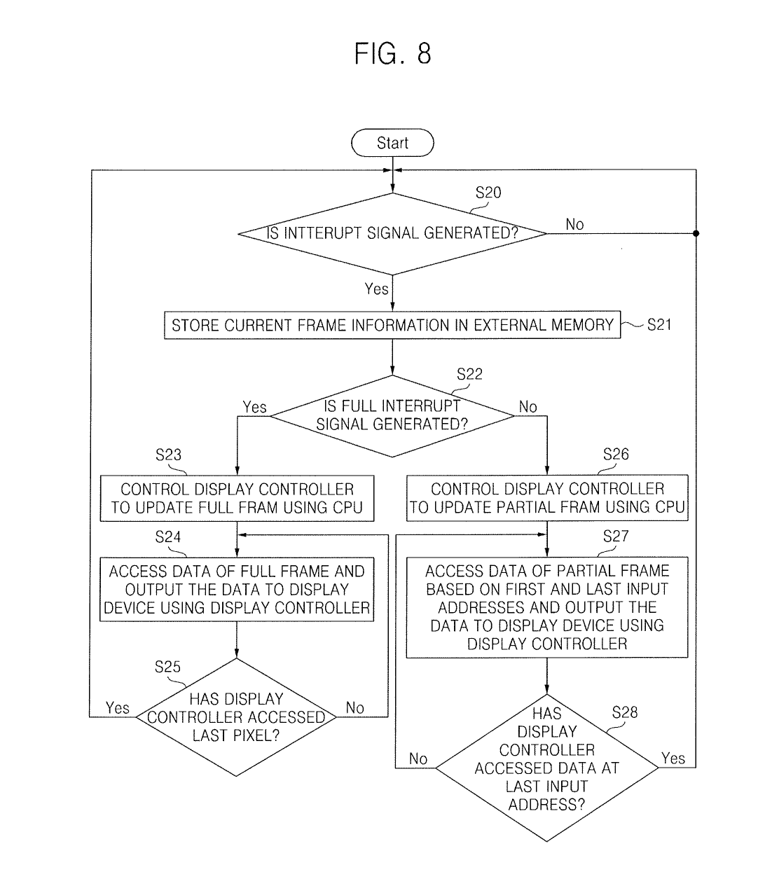

FIG. 8 is a flowchart of a method of operating the SoC 1a performed after the interrupt generation in the method illustrated in FIG. 7. Referring to FIG. 8, when the UD unit 50A generates an interrupt signal in operation S20, it stores current frame information in the external memory 2 in operation S21. The current frame information is used as previous frame information during the update detection operation on a subsequent frame after a predetermined time elapses.

When the interrupt signal is the full interrupt signal in operation S22, the CPU 20 controls the display controller 80 to update the update region, e.g., the full frame on the display device 3 in operation S23. According to the control of the CPU 20, the display controller 80 accesses data of the full frame in the external memory 2 and outputs the data to the display device 3 in operation S24. The display controller 80 accesses the data up to the last pixel of the full frame, which corresponds to the full frame end address, in the external memory 2 and outputs all data of the full frame to the display device 3 in operation S25.

When the interrupt signal is the partial interrupt signal in operation S22, the CPU 20 controls the display controller 80 to update the update region, e.g., the partial frame on the display device 3 in operation S26. According to the control of the CPU 20, the display controller 80 accesses data of the partial frame in the external memory 2 and outputs the data to the display device 3 in operation S27. The display controller 80 accesses the data of the partial frame based on the first input address and the last input address, which are stored in the SFR 51 a. The display controller 80 accesses the data up to the last pixel of the partial frame, which corresponds to the last input address, in the external memory 2 and outputs all data of the partial frame to the display device 3 in operation S28.

When it is determined that the update has not occurred as a result of comparing the previous frame with the current frame or when the request of the image generator 70 does not relate to a frame update, no interrupt signal is generated in operation S20. The CPU 20 waits for any interrupt signal to be generated.

As described above, according to embodiments of the inventive concepts, a SoC reduces the number of frame updates and the amount of updated data in a display device. As a result, a system including the SoC reduces power consumption.

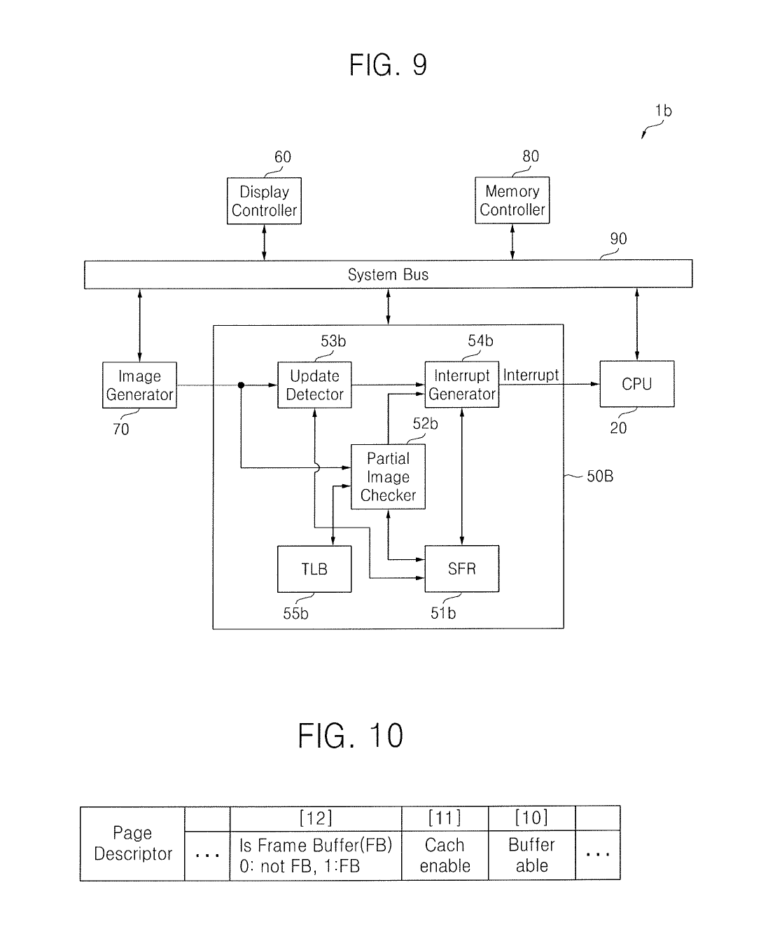

FIG. 9 is a detailed block diagram of a SoC 1 b according to embodiments of the inventive concept. FIG. 10 is a table showing a page descriptor field included in a TLB 55b illustrated in FIG. 9. Some of the differences between the arrangement illustrated in FIG. 9 and the arrangement illustrated in FIG. 4 will be described.

Referring to FIG. 9, a UD unit 50B includes an SFR 51b, a partial image checker 52b, an update detector 53b, and an interrupt generator 54b. The operations of the elements 51b through 54b are substantially the same as those of the elements 51a through 54a illustrated in FIG. 4. However, unlike the partial image checker 52a illustrated in FIG. 4, the partial image checker 52b checks an “Is Frame Buffer” field in a page descriptor stored in the TLB 55b and determines whether to enable the frame detection operation.

The SoC 1b includes a plurality of page table entries in the TLB 55b. Mapping information between a 32-bit or 64-bit virtual address and a physical address is stored in each page table entry. The mapping information is stored in a format defined by the page descriptor.

Meanwhile, the mapping information is also stored in the page table within the external memory 2. In a case of TLB miss in which a virtual address corresponding to the request of the image generator 70 does not exist in the TLB 55b, the page table walk may be performed to find the mapping information in the page table.

As shown in FIG. 10, the mapping information, i.e., the page descriptor may include the Is Frame Buffer field. The Is Frame Buffer may information of a frame is stored in a twelfth bit [12] among 32 bits. When the Is Frame Buffer field is “0”, it indicate that the request of the image generator 70 does not relate to a frame of an image, e.g., an image frame. When it is “1”, it indicates that the request of the image generator 70 relates to the image frame. Accordingly, the UD unit 50B checks the Is Frame Buffer field in the TLB 55b or the page table and enables (or activates) the frame detection operation of the partial image checker 52b only when the request of the image generator 70 relates to the image frame.

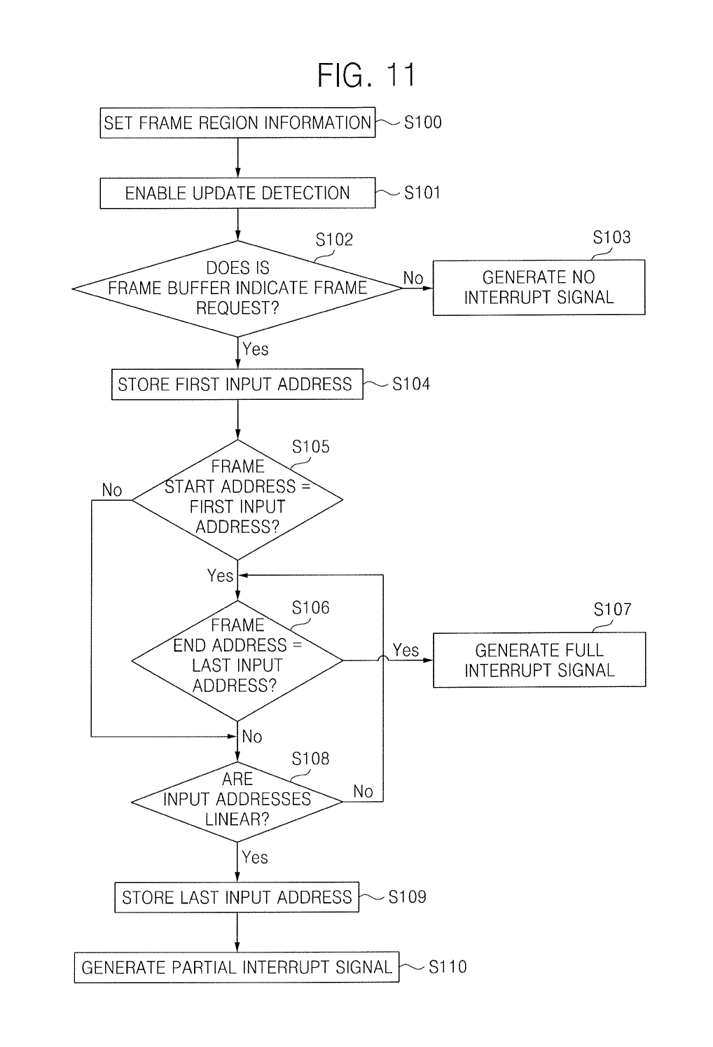

FIG. 11 is a flowchart of a method of operating the SoC 1b illustrated in FIG. 9. Referring to FIG. 11, the CPU 20 sets frame region information in the UD unit 50B in operation S100. The frame region information includes a full frame start address and a full frame end address.

The CPU 20 instructs the image generator 70 to generate or process an image. The image generator 70 requests the UD unit 50B to operate on a current frame according to the instruction of the CPU 20 and the UD unit 50B enables an update detection operation in operation S101. The UD unit 50B checks the Is Frame Buffer field of a page descriptor in the TLB 55b to find out whether the request of the image generator 70 relates an image frame in operation S102. When the request is not an image frame request, an interrupt signal is not generated in operation S103.

However, the request is the image frame request in operation S102, the UD unit 50B stores a first input address included in the request of the image generator 70 in the SFR 51b in operation S104 while translating a virtual address into a physical address using TLB 55b. When the first input address is the same as the full frame start address set in the SFR 51b in operation S105 and a last input address is the same as the full frame end address set in the SFR 51b in operation S106, the UD unit 50B determines that a requested update region is a full frame and, when an update occurs, generates a full interrupt signal in operation S107.

When the first input address is not the same as the full frame start address set in the SFR 51b in operation S105 and subsequent input addresses are linear in operation S108, the UD unit 50B determines that the update region is a partial frame and stores the last input address in operation S109. When the update occurs, the UD unit 50B generates a partial interrupt signal in operation S110.

When the first input address is the same as the full frame start address set in the SFR 51b in operation S105, the last input address is not the same as the full frame end address set in the SFR 51b in operation S106, and subsequent input addresses are linear in operation S108, the UD unit 50B determines that the update region is the partial frame and stores the last input address in operation S109. When the update occurs, the UD unit 50B generates the partial interrupt signal in operation S110.

The operation of the SoC 1b after the generation of the interruption signal is the same as that illustrated in FIG. 8.

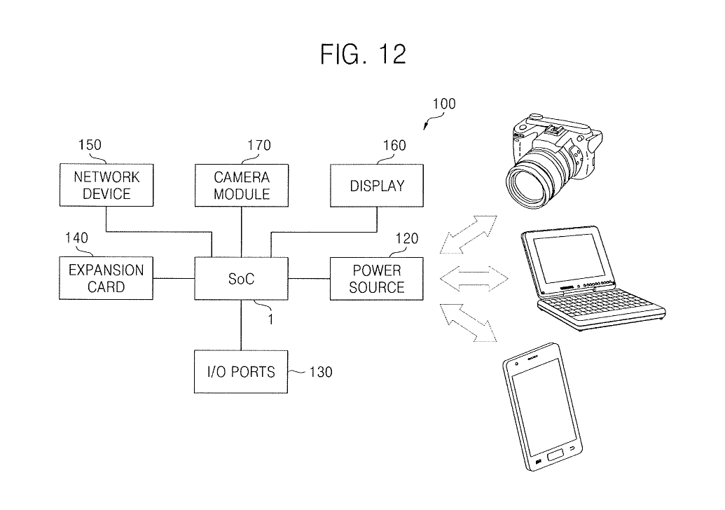

FIG. 12 is a block diagram of a system 100 including the SoC according to embodiments of the inventive concept. The system 100 illustrated in FIG. 12 may be substantially same as the system illustrated in FIG. 1.

The system 100 may include the SoC 1, a power source 120, I/O ports 130, an expansion card 140, a network device 150, and a display 160. The system 100 may further include a camera module 170.

The SoC 1 may control the operation of at least one of the elements 120 through 170. The power source 120 may supply an operating voltage to at least one of the elements 1, and 130 through 170.

The I/O ports 130 are ports that receive data transmitted to the system 100 or transmit data from the system 100 to an external device.

The expansion card 140 may be implemented as a secure digital (SD) card or a multimedia card (MMC). The expansion card 140 may be a subscriber identity module (SIM) card or a universal SIM (USIM) card.

The network device 150 enables the system 100 to be connected with a wireless network. The display 160 displays data output from the I/O ports 130, the expansion card 140, or the network device 150. The display 160 corresponds to the display device 3 illustrated in FIG. 1. The display 160 may be called as the display device.

The camera module 170 converts optical images into electrical images. Accordingly, the electrical images output from the camera module 170 may be stored in the SoC 1, or the expansion card 140. Also, the electrical images output from the camera module 170 may be displayed through a display 160.

The camera module 170 includes an image sensor (not shown).

As described above, according to embodiments of the inventive concept, when a current frame is updated, a SoC determines whether an update region of the current frame is a partial frame based on virtual addresses and only data corresponding to the update region is transmitted to a display device while data that does not correspond to the update region is not transmitted, thereby reducing the number of frame updates and the amount of updated data are reduced in the display device. As a result, the power consumption of a system including the SoC is also reduced.

While the inventive concept has been particularly shown and described with reference to exemplary embodiments thereof, it will be understood by those of ordinary skill in the art that various changes in forms and details may be made therein without departing from the spirit and scope of the inventive concept.

What is claimed is:

1. A system on chip (SoC) comprising:
a central processing unit (CPU) configured to control operation of a memory device and a display device for a current frame of an image according to an interrupt signal;
an image generator configured to request data of the current frame from the memory device according to control of the CPU;
a UD unit configured to determine whether the current frame has been updated, to detect whether an update region is a partial frame based on virtual addresses comprised in a request of the image generator, and to output the interrupt signal corresponding to the update region to the CPU;
a memory controller configured to store the update region in the memory according to the control of the CPU; and
a display controller configured to access the memory device and output the update region to the display device according to the control of the CPU.

2. The SoC of claim 1, wherein the UD unit is configured to:
compare the virtual addresses comprised in the request of the image generator with predetermined frame region information to detect whether the update region is the partial frame or a full frame;
compare data of a previous frame corresponding to the update region with the data of the current frame; and
generate the interrupt signal when an update occurs.

3. The SoC of claim 1, wherein the UD unit comprises:
a special function register (SFR) configured to store frame region information;
a partial image checker configured to compare the virtual addresses comprised in the request of the image generator with the frame region information to detect whether the update region is the partial frame or a full frame and to output a detection result;
an update detector configured to compare the current frame with a previous frame and transmit a comparison result to the SFR and to transmit the data of the current frame to the memory when an update occurs; and
an interrupt generator configured to output the interrupt signal to the CPU based on the comparison result and the detection result.

4. The SoC of claim 3, wherein the frame region information comprises a full frame start address and a full frame end address.

5. The SoC of claim 4, wherein when update detection is enabled,
the partial image checker determines the detection result as the partial frame when a first input address comprised in the request of the image generator is not the full frame start address and subsequent input addresses are linear,
the SFR stores the first input address and a last input address, and
the interrupt generator generates a partial interrupt signal based on the detection result and the comparison result.

6. The SoC of claim 4, wherein when update detection is enabled,
the partial image checker determines the detection result as the partial frame when a first input address comprised in the request of the image generator is the full frame start address, a last input address is not the full frame end address, and input addresses between the first input address and the last input address are linear,
the SFR stores the first input address and the last input address, and
the interrupt generator generates a partial interrupt signal based on the detection result and the comparison result.

7. The SoC of claim 4, wherein when update detection is enabled,
the partial image checker determines the detection result as the full frame when a first input address comprised in the request of the image generator is the full frame start address and a last input address is the full frame end address, and
the interrupt generator generates a full interrupt signal based on the detection result and the comparison result.

8. The SoC of claim 3, wherein the update detector compares a check sum of the previous frame with a check sum of the current frame and transmits a comparison result to the interrupt generator and the SFR stores the check sum of the current frame.

9. The SoC of claim 3, wherein the update detector compares a result of cyclic redundancy check (CRC) of the previous frame with a CRC result of the current frame and transmits a comparison result to the interrupt generator and the SFR stores the CRC result of the current frame.

10. The SoC of claim 4, wherein the update region is the image corresponding to the first input address, the last input address, and input addresses between the first input address and the last input address.

11. The SoC of claim 3, wherein the UD unit further comprises a translation lookaside buffer (TLB) configured to store a plurality of page table entries comprising a physical address, which matches a virtual address in the request of the image generator, and an Is Frame Buffer field indicating whether the virtual address relates to the image, and
the partial image checker enables a frame detection operation based on the Is Frame Buffer field.

12. A method of operating a system on chip (SoC), the method comprising:
controlling an image generator to request generation of an image and enable an update detection operation using a central process unit (CPU);
detecting whether an update region in a current frame of the image is a partial frame based on frame region information;
determining whether an update occurs by comparing the current frame with a previous frame of the image;
generating an interrupt signal corresponding to the update region when the update occurs;
storing the update region in a memory device when the interrupt signal is generated; and
accessing the memory device, reading the update region, and outputting the update region to a display device using a display controller.

13. The method of claim 12, further comprising setting a full frame start address and a full frame end address as the frame region information using the CPU before the enabling the update detection operation,
wherein the detecting whether the update region is the partial frame comprises storing a first input address and a last input address, which are comprised in a request of the image generator, as the frame region information.

14. The method of claim 13, wherein the detecting whether the update region is the partial frame comprises determining the update region as the partial frame when the first input address comprised in the request of the image generator is not the full frame start address and subsequent input addresses are linear, and
the generating the interrupt signal comprises generating a partial interrupt signal.

15. The method of claim 13, wherein the detecting whether the update region is the partial frame comprises determining the update region as the partial frame when the first input address comprised in the request of the image generator is the full frame start address, the last input address is not the full frame end address, and input addresses between the first input address and the last input address are linear, and
wherein the generating the interrupt signal comprises generating a partial interrupt signal.

16. The method of claim 13, wherein the detecting whether the update region is the partial frame comprises determining the update region as a full frame when the first input address comprised in the request of the image generator is the full frame start address and the last input address is the full frame end address, and
wherein the generating the interrupt signal comprises generating a full interrupt signal.

17. A mobile electronic device, comprising:
a memory device;
a display device; and
a system-on-chip (SoC), the SoC comprising:
a central processing unit (CPU) configured to control an operation of the memory device;
an image generator configured to request image data from the memory device;
an update unit configured to determine whether a current frame of the requested image data is updated as compared to a previous frame of the requested image data and, when it is determined that the current frame is updated, to determine whether the updates apply only to a partial frame of the current frame and to provide an interrupt signal when it is determined that the current frame is updated and the updates apply only to the partial frame,
wherein the display device is configured to refresh only the partial frame when the interrupt signal is provided.

18. The mobile electronic device of claim 17, wherein the memory device is external to the SoC.

19. The mobile electronic device of claim 17, wherein the image generator, the update unit, and the display device are under the control of the CPU.

20. The mobile electronic device of claim 17, wherein the update unit is configured to determine whether the updates apply only to a partial frame of the current frame by analyzing virtual addresses of the requests of the image generator.
